(19) United States
(12) Patent Application Publication
(10) Pub. No.: US 2013/0205065 A1
(43) Pub. Date: Aug. 8, 2013

(54) METHODS AND STRUCTURE FOR AN IMPROVED SOLID-STATE DRIVE FOR USE IN CACHING APPLICATIONS

(71) Applicants: John R. Kloeppner, Buhler, KS (US); Mohamad H. El-Batal, Superior, CO (US)

(72) Inventors: John R. Kloeppner, Buhler, KS (US); Mohamad H. El-Batal, Superior, CO (US)

(73) Assignee: LSI CORPORATION, Milpitas, CA (US)

(21) Appl. No.: 13/365,050

(22) Filed: Feb. 2, 2012

(51) Int. Cl. G06F 12/00

(52) U.S. Cl. 711/103; 711/E12.008

(57) ABSTRACT

Methods and structure for an improved solid-state drive (SSD) for use in caching applications. An improved SSD comprises both volatile and non-volatile memory. The volatile memory provides improved performance as compared to present SSDs for use in caching application. The improved SSD senses impending failure of external power applied to the SSD and, while adequate power remains, copies cached data from the volatile memory to the non-volatile memory to retain the data through the power loss. In some embodiments, a local power source may be present to assure sufficient time for the SSD to save cached data in the non-volatile memory. Since the volatile memory (e.g., DRAM) is used for the primary caching function and the non-volatile memory is rarely used, performance, reliability and cost goals are achieved for write cache applications.

### BACKGROUND

1. Field of the Invention

The invention relates generally to solid-state drives (SSDs) and more specifically relates to an improved SSD design useful for caching applications.

2. Related Patents

This patent is related to commonly owned U.S. patent application Ser. No. 13/281,301 entitled METHODS AND SYSTEMS USING SOLID-STATE DRIVES AS STORAGE CONTROLLER CACHE MEMORY which is hereby incorporated by reference (hereinafter referred to as “Sibling”).

3. Discussion of Related Art

Solid-state drive (SSDs) are storage devices utilizing non-volatile semiconductor (solid-state) memory devices (often using flash memory components) and a controller circuit that presents the memory as a disk drive to interface with attached host systems and storage controllers as a standard magnetic/optical disk drive would interface. SSDs provide low power and high performance as compared to common rotating magnetic/optical media storage devices at a somewhat higher cost (e.g., cost per byte of storage).

The Sibling patent presents an architecture for utilizing SSDs as a replacement for cache memory in storage controllers. The Sibling patent discusses a number of beneficial features in such an architecture. SSDs, though fast by comparison with standard rotating disk drives, are not as fast as the cache memory components commonly used in previous storage controllers and, as noted, can present some challenges in terms of cost. Flash memories (and hence SSDs using such components) are not as fast as RAM memories more commonly used for caching of data in storage controllers. Further, flash memory components are not generally as fast as even lower cost RAM components commonly employed for cache memory applications. In addition, present-day SSDs provide much larger capacities than is typically required for cache memory applications. The excess capacity of present-day SSDs renders them less practical for use as cache memory in storage controllers.

Thus it is an ongoing challenge to practically utilize present-day SSDs as replacements for cache memory in storage controllers (or in other cache memory applications).

### SUMMARY

The present invention solves the above and other problems, thereby advancing the state of the useful arts, by providing methods and structure for an improved SSD that comprises both volatile and non-volatile memory. The volatile memory provides improved performance as compared to present SSDs for use in caching application. The improved SSD senses impending failure of external power applied to the SSD and, while adequate power remains, copies cached data from the volatile memory to the non-volatile memory to retain the data through the power loss. In some embodiments, a local power source may be present to assure sufficient time for the SSD to save cached data in the non-volatile memory.

In one aspect hereof, an improved solid-state drive (SSD) for use as a cache memory is provided. The SSD comprising a volatile random access memory (RAM) for storing cached data and a non-volatile random access memory (NVRAM). The SSD further comprising a controller circuit coupled with the RAM and coupled with the NVRAM. The controller circuit is adapted to present the storage of the RAM as a disk drive when coupled with an external device. The controller circuit is further adapted to couple with the external device to receive cached data from the external device and further adapted to store received cached data in the RAM. The controller circuit is further adapted to sense an impending loss of external power to the SSD and is further adapted to copy cached data stored in the RAM into the NVRAM responsive to sensing the impending loss of external power.

Another aspect hereof provides a storage system comprising a plurality of storage controllers adapted to couple with one or more host systems and a plurality of storage devices for persistent storage of user data received from the one or more host systems. The system further comprises a switched fabric communication medium coupling the plurality of storage controllers with each of the plurality of storage devices and at least one improved SSD as above coupled with each of the plurality of storage controllers through the switched fabric communication medium.

Still another aspect hereof provides a method of operating such an improved SSD that has both high-speed volatile memory and non-volatile memory. The method comprising receiving a request from the external device to store cached data and storing received cached data in the RAM responsive to receipt of the request to store cached data. The method further comprises receiving a request from the external device to read previously stored cached data and returning requested cached data from the RAM to the external device responsive to receipt of the request to read previously stored cached data. The method also comprises sensing an impending loss of external power to the SSD and, responsive to sensing the impending loss of external power, copying cached data from the RAM to the NVRAM.

### BRIEF DESCRIPTION OF THE DRAWINGS

FIG. 1 is a block diagram of an exemplary system incorporating solid-state drives (SSDs) enhanced in accordance with features and aspects hereof

FIG. 2 is a block diagram providing exemplary additional details for an embodiment of the improved SSD of FIG. 1 in accordance with features and aspects hereof

FIGS. 3 through 6 are flowcharts describing exemplary methods of operation of an improved SSD in accordance with features and aspects hereof.

### DETAILED DESCRIPTION OF THE DRAWINGS

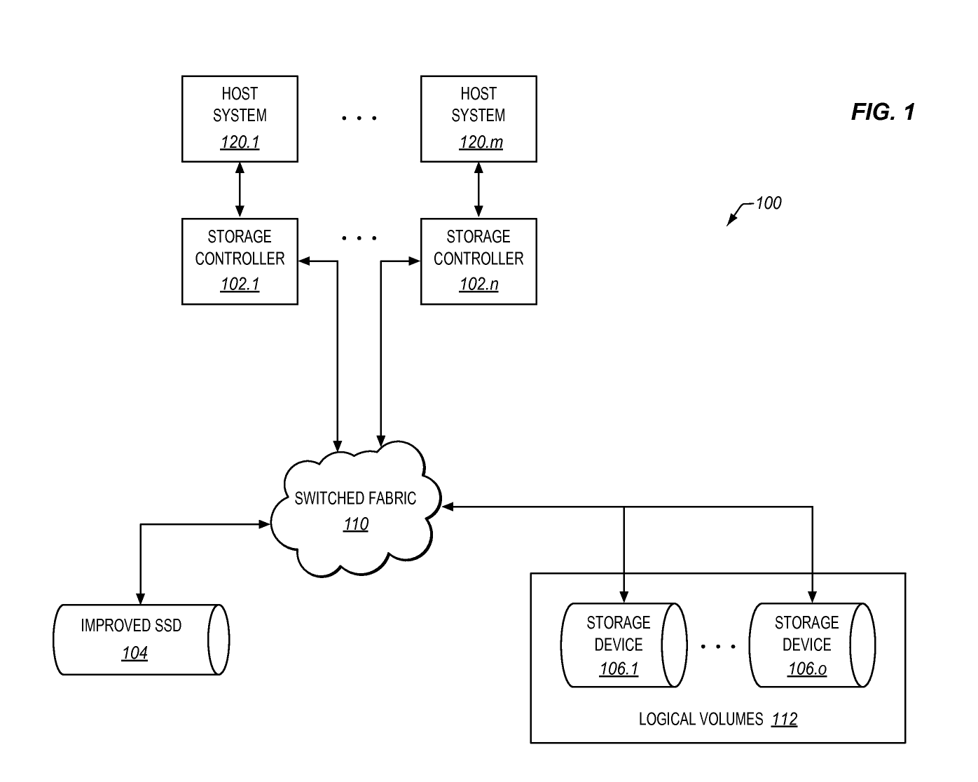

FIG. 1 is a block diagram of an exemplary system 100 enhanced in accordance with features and aspects hereof to utilize one or more improved solid-state drives (SSDs) 104 as cache memory for attached external devices. System 100 includes a plurality of storage controllers (e.g., external devices) 102.1 through 102.n (sometimes singly and collectively referred to herein by the common reference number 102). Each storage controller 102 comprises any suitable electronic component or device adapted to receive I/O requests from one or more host systems 120.1 through 120.m and adapted to process each received I/O request by accessing data on an identified volume of one or more logical volumes 112. In some exemplary embodiments, each storage controller 102 comprises a general and/or special purpose processor coupled with associated program memory for storing programmed instructions and data to control operation of the storage controller. In some exemplary embodiments, storage controller 102 may be physically integrated within a corresponding host system 120 (e.g., as a host bus adapter (HBA) or as circuits integrated with the computational circuits of the host system). In other exemplary embodiments, storage controllers 102 may be physically integrated with other components of a storage system and coupled with host systems 120 through any suitable communication medium and protocol such as Serial Attached SCSI (SAS), Fibre Channel (FC), Serial Advanced Technology Attachment (SATA), Ethernet, etc.

Each logical volume 112 comprises portions of one or more storage devices 106.1 through 106.o (singly and collectively sometimes referred to herein by the common reference number 106). In one exemplary embodiment, storage devices 106 each comprise a rotating magnetic or optical storage device (e.g., a magnetic or optical disk drive) or a solid-state drive.

Each of the plurality of storage controllers is coupled to the plurality of storage devices 106 and to the one or more improved SSDs 104 through a switched fabric communication medium 110. Switched fabric 110 may use any of several well-known, commercially available communication media and protocols including, for example, SAS, FC, Ethernet, etc. Thus, each storage controller 102 has access to any of SSDs 104 to use as a cache memory in processing received I/O requests. Those of ordinary skill in the art will further recognize that in a fully redundant configuration, there may be multiple switched fabrics (110) and that each SSD 104 and each controller 102 may be coupled to each of the multiple switched fabrics. Similarly, there may be redundant communication paths (e.g., switched fabrics) between each host 120 and each of the controllers 102. Thus, full redundancy may be achieved in all communications paths relating to the system.

The Sibling patent application discusses techniques used to allocate portions of the storage capacity of SSDs 104 as well as other methods and structures related to use of SSDs as cache memory for attached storage controllers. As taught by the Sibling patent application, an SSD may be used as a cache memory by controllers 102 for storing and retrieving cached data on the SSD. SSD 104 presents itself to controllers 102 (or other external devices) as though it is a disk drive—i.e., addressed by logical block addresses—LBAs. In general, presently known SSDs include control logic for overall control of the SSD and for interfacing with the host systems and include a memory component for storing cached data and for retrieving previously stored cached data. However, present SSDs as discussed above in the Background, tend to provide lower performance than is desirable for caching applications and at the same time tend to provide more storage capacity than is typically required for such caching application (thus increasing costs).

In accordance with features and aspects hereof, each SSD 104 is improved to provide a volatile, high speed, Random Access Memory (RAM) component for high performance storage of cached data as well as a non-volatile (NVRAM) that retains data through loss of power for desired reliability. The combination of memory components is used to provide both reliability and performance. Further, the size of the memory components of improved SSD 104 may be selected for best utilization in caching applications.

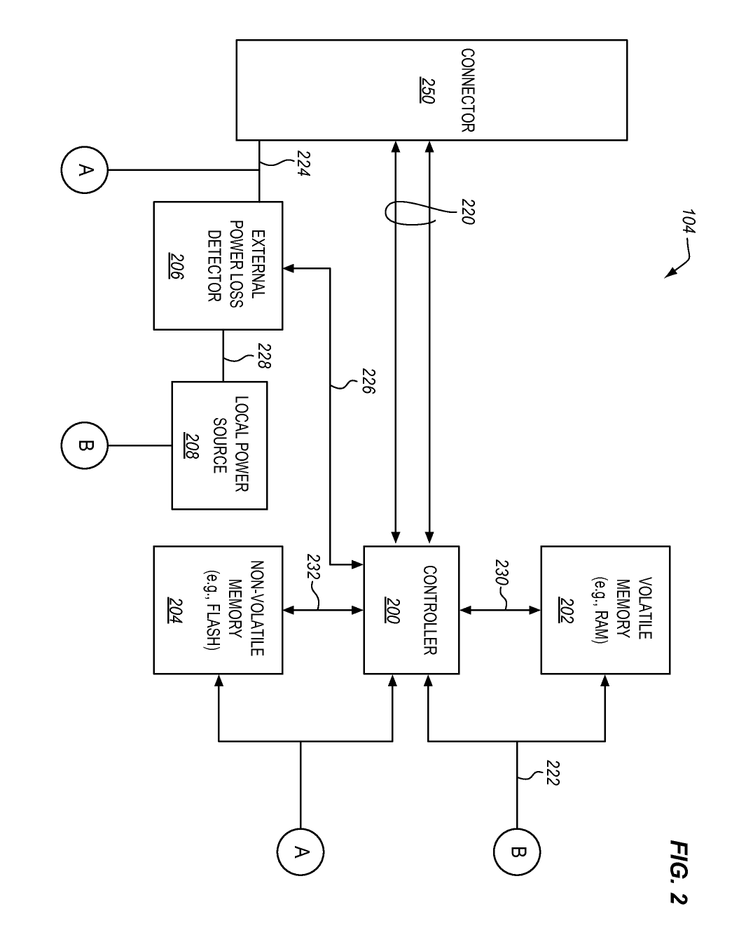

FIG. 2 is a block diagram describing additional details of the structure of an exemplary embodiment of improved SSD 104 of FIG. 1. SSD 104 comprises a controller circuit 200 adapted to control overall operation of SSD 104. In particular, controller 200 provides logic for presenting the storage capacity of SSD 104 as a disk drive to externally attached devices. Controller 200 couples with one or more external devices via one or more communication channels 220 through connector 250. Controller 200 may be any suitable electronic circuit or device adapted to control overall operation of SSD 104 including, for example, a general or special purpose programmable processor with associated program memory, a microcontroller with associated program memory, etc. Communication channels 220 may be any suitable communication media and protocol for coupling SSD 104 with one or more external devices such as an external host system and/or storage system controller. Communication channels 220 may be implemented utilizing any of several well-known, commercially available communication media and protocol including, for example, Fibre Channel (FC), Serial Attached SCSI (SAS), Serial Advanced Technology Attachment (SATA), etc.

An external power source (not shown) provides electrical power through connector 250 on path 224 for operation of SSD 104. In particular, external power applied to pass to 24 provides operational power for controller 200 as indicated by label “A.”. SSD 104 further comprises a volatile memory component 202 (e.g., a dynamic or static Random Access Memory “RAM” component) providing a high-speed storage for data received by controller 200 from an attached external device. Utilizing the high-speed features of volatile memory RAM 200, SSD 104 provides high-performance as is desired in caching applications of such an SSD. Further, volatile memory 202 may be appropriately sized for cache memory applications rather than wasteful by providing far more storage capacity than needed as compared to standard SSDs. Volatile memory 202 also receives power from external power source (label “A”). Still further, SSD 104 comprises non-volatile memory component 204. In some exemplary embodiments, non-volatile memory 204 may be implemented utilizing flash memory technology and may be similarly sized to the storage capacity of volatile memory component 202. Volatile memory 202 and non-volatile memory 204 are both coupled with controller 200 via appropriate processor or memory buses 230 and 232, respectively. Improved SSD 104 further comprises external power loss detector 206 coupled to receive externally supplied power via path 224 and adapted to detect an impending loss of such external power. Upon detecting such an impending loss, external power loss detector 206 applies an associated signal via path 226 to controller 200. In an exemplary embodiment the externally supplied power and the power from local power source 208 will be connected through a power diode (e.g., within detector 206). The voltage of the local power source would be slightly below that of the external power voltage. Thus, the external power voltage the power diode will not be “forward biased” so it will not discharge when external power is applied. When the external power drops (e.g., commencing a loss of external power) the voltage will drop until the power diode forward biases thus causing the local power source 208 to maintain power to the SSD 104. Detector 206 logic will sense the external power dropping and signal controller 200 to initiate the “offload” (copying) of data in volatile memory 202 (e.g., “dirty” data not yet flushed to the storage devices) while local power source 208 maintains operational power for SSD 104 for a sufficient period of time to complete the copying.

In operation, controller 200 received requests via path 220 from an external device to store provided write data (as cached data) in volatile memory 202. Responsive to such a request, controller 200 stores the data provided with the request in volatile memory 202. Further, controller 200 may receive requests from external devices via path 220 to retrieve previously stored cached data. Responsive to such requests, controller 200 retrieves identified data from volatile memory 202 and returns the requested data as “read data” to the requesting external device. Further, responsive to receipt of a signal from detector 206, controller 200, sensing likely impending loss of externally supplied power, copies all cached data presently stored in volatile memory 202 into non-volatile memory 204. Thus, cached data stored in volatile memory 202 may be reliably saved before loss of power while still providing dramatically improved performance in caching applications as compared to present day SSD devices. Further, responsive to sensing restoration of externally supplied power on path 224, controller 200 copies data saved in non-volatile memory 204 into volatile memory 202 to restore previously cached data to the high-performance memory of volatile memory 202. If controller 200 receives a request to retrieve cached data before the contents of memory 202 has been fully restored, the request may be completed by returning the data as stored in the non-volatile memory 204. In some embodiments, SSD 104 may continue processing further requests to cache data as data is being copied from non-volatile memory 204 back into volatile memory 202. Such data received from an external device while the data is being restored to volatile memory 202 may be written to both devices (202 and 204) to assure that all data is properly restored to the high-performance volatile memory 202.

In some exemplary embodiments, SSD 104 further comprises local power source 208 for providing local power (label “B”) to components of improved SSD 104. Responsive to detecting impending loss of external power by detector 206, local power source 208 may be enabled by an appropriate signal applied to path 228 enabling application of power from local power source 208 to path 222 for continued operation of controller 200, memory 202, and memory 204. In some embodiments, local power source 208 may be a “super capacitor” or an appropriate battery. Examples of such local power sources suitable for short-term operation of SSD 104 are well known to those of ordinary skill in the art and are readily available. Local power source 208 need only provide enough power to permit controller 200 enough time to copy contents of volatile memory 202 into non-volatile memory 204. Though inclusion of such a local power source 208 in SSD 104 represents the best known mode, those of ordinary skill in the art will recognize that in some circumstances a local power source may not be required. For example, where the amount of data to be copied or offloaded from the volatile memory to the non-volatile memory is small, the offload copying may be performed quickly enough that the dropping external power will provide sufficient power to complete the brief offload procedure without the need for a local power source. In most practical applications of SSD 104, a local power source will be useful to assure sufficient time to complete the offload processing regardless of the volume of data to be copied.

Those of ordinary skill in the art will readily recognize numerous additional and equivalent components present in a fully functional improved SSD 104. Such additional and equivalent elements are omitted herein for simplicity and brevity of this discussion.

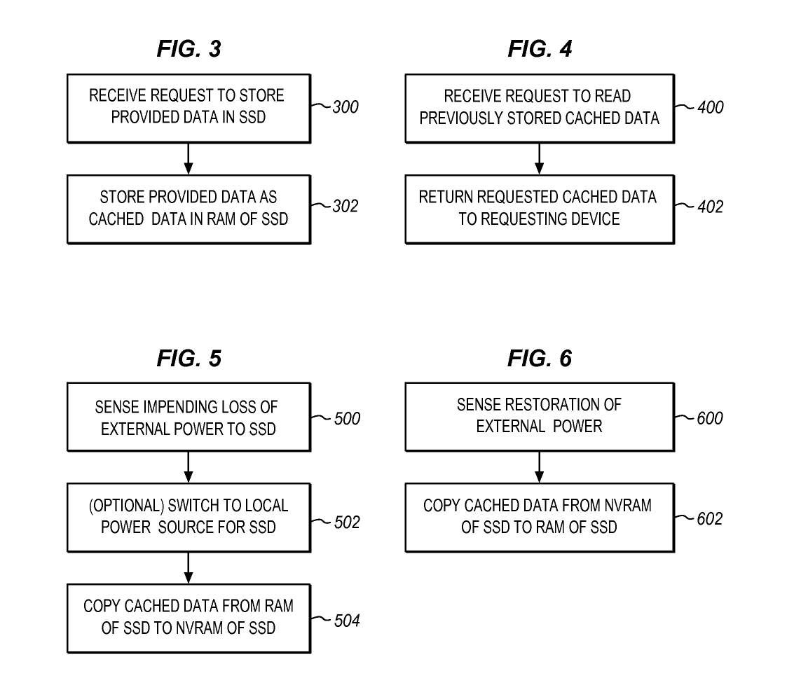

FIGS. 3 through 6 are flowcharts describing exemplary methods for operating an improved SSD in accordance with features and aspects hereof The methods of FIGS. 3 through 6 may be operable in an improved SSD such as SSD 104 of FIGS. 1 and 2. Such an improved SSD, as discussed above, includes both a high-speed volatile memory component for providing high-speed access in caching applications of the SSD and also includes a non-volatile memory component used for saving contents of the high-speed volatile memory component in case of impending loss of external power to improved SSD. Step 300 of FIG. 3 receives a request to store data (e.g., write data provided with the request) in the improved SSD memory as newly cached data. Responsive to receipt of such a request, step 302 stores the provided data as cached data in the high-speed RAM (volatile memory) of the improved SSD. Step 400 of FIG. 4 receives a request to read previously stored cached data from the high-speed memory (volatile memory) of the improved SSD. Responsive to such a request, step 402 returns the requested cached data as read data to the requesting external device. Thus, the methods of FIGS. 3 and 4 represent exemplary processing typical in any application of an SSD for purposes of caching data for external devices.

Step 500 of FIG. 5 senses and impending loss of external power to the improved SSD. Loss of externally supplied power may be sensed as a threshold drop in voltage of the externally supplied power though the voltage remains sufficient to continue operation of the improved SSD for a brief period of time. As noted above, in some embodiments (e.g., most practical embodiments), a local power source may be provided in the improved SSD such that at step 502, responsive to sensing the impending loss of external power to the improved SSD, the SSD switches its power source for operational circuits (i.e., controller logic, high-speed volatile memory, and non-volatile memory) to the local power source of the SSD. As noted above such a local power source may comprise a suitable battery and/or a “super capacitor”. Responsive to sensing the impending loss of external power, step 504 copies (“offloads”) the present contents of cached data from the high-speed, volatile RAM memory component to the non-volatile RAM memory component of the SSD. Meta-data associated with the cached data may be useful to minimize the volume of information that needs to be copied to the non-volatile memory. Thus, cached data survives the potential impending loss of power to the improved SSD by virtue of being copied to the non-volatile memory of the improved SSD. Step 600 of FIG. 6 senses a restoration of the power provided by the external power source. Responsive to sensing restoration of such power, step 602 copies the cached data saved in the non-volatile RAM of the SSD back into the high-speed, volatile RAM memory component of the SSD to thereby restore desired performance for caching applications of the improved SSD. As noted above, the SSD may receive and process new requests to access cached data while the data is being restored to the volatile RAM. Read requests to retrieve previously cached data may be completed by reading the requested data from the non-volatile memory while the restoration copying progresses. Write requests to store new cached data in the SSD may be completed by writing the new data to both the volatile and non-volatile memories while the restoration copying progresses. Once all data has been restored to the volatile memory, normal operation of the SSD may resume processing requests to store or retrieve cached data in the high-speed, volatile memory of the SSD.

Those of ordinary skill in the art will readily recognize numerous additional and equivalent steps in fully functional methods such as the methods of FIGS. 3 through 6. Such additional and equivalent steps are omitted here and for simplicity and brevity of this discussion.

While the invention has been illustrated and described in the drawings and foregoing description, such illustration and description is to be considered as exemplary and not restrictive in character. One embodiment of the invention and minor variants thereof have been shown and described. In particular, features shown and described as exemplary software or firmware embodiments may be equivalently implemented as customized logic circuits and vice versa. Protection is desired for all changes and modifications that come within the spirit of the invention. Those skilled in the art will appreciate variations of the above-described embodiments that fall within the scope of the invention. As a result, the invention is not limited to the specific examples and illustrations discussed above, but only by the following claims and their equivalents.

What is claimed is:

1. A solid-state drive (SSD) for use as a cache memory, the SSD comprising:
a volatile random access memory (RAM) for storing cached data;
a non-volatile random access memory (NVRAM); and
a controller circuit coupled with the RAM and coupled with the NVRAM,
wherein the controller circuit is adapted to present the storage of the RAM as a disk drive when coupled with an external device,
wherein the controller circuit is further adapted to couple with the external device to receive cached data from the external device and further adapted to store received cached data in the RAM,
wherein the controller circuit is further adapted to sense an impending loss of external power to the SSD, and
wherein the controller circuit is further adapted to copy cached data stored in the RAM into the NVRAM responsive to sensing the impending loss of external power.

2. The SSD of claim 1
wherein the NVRAM is a flash memory.

3. The SSD of claim 1
wherein the controller circuit comprises at least two interface circuits for coupling with multiple attached external devices.

4. The SSD of claim 3
wherein each interface circuit comprises one of: a Serial Advanced Technology Attachment (SATA) interface and a Serial Attached SCSI (SAS) interface.

5. The SSD of claim 1
wherein the RAM and the NVRAM have substantially the same storage capacity.

6. The SSD of claim 1 further comprising:
a local power source integral with the SSD for supplying temporary power to the SSD in the event of a loss of external power to the SSD,
wherein the controller circuit is further adapted to copy cached data stored in the RAM into the NVRAM using power from the local power source.

7. The SSD of claim 6
wherein the local power source is a super-capacitor.

8. The SSD of claim 1
wherein the controller circuit is further adapted to sense restoration of external power, and
wherein the controller circuit is further adapted to copy cached data from the NVRAM to the RAM responsive to sensing restoration of external power.

9. A method operable in a solid-state drive (SSD) wherein the SSD comprises a volatile random access memory (RAM) and a non-volatile random access memory (NVRAM) and a controller circuit the presents the storage of the RAM as a disk drive to an external device, the method comprising:
receiving a request from the external device to store cached data;
storing received cached data in the RAM responsive to receipt of the request to store cached data;
receiving a request from the external device to read previously stored cached data;
returning requested cached data from the RAM to the external device responsive to receipt of the request to read previously stored cached data;
sensing an impending loss of external power to the SSD; and
responsive to sensing the impending loss of external power, copying cached data from the RAM to the NVRAM.

10. The method of claim 9 wherein the controller circuit comprises at least two interface circuits for coupling with multiple attached external devices and wherein the steps of receiving request from the external device further comprises receiving requests from any of multiple external devices.

11. The method of claim 9 wherein the SSD further comprises a local power source integral with the SSD for supplying temporary power to the SSD in the event of a loss of external power to the SSD,
wherein the method further comprises:
copying cached data stored in the RAM into the NVRAM using power from the local power source.

12. The method of claim 9 further comprising:
sensing restoration of external power, and
copying cached data from the NVRAM to the RAM responsive to sensing restoration of external power.

13. A system comprising:
a plurality of storage controllers adapted to couple with one or more host systems;
a plurality of storage devices for persistent storage of user data received from the one or more host systems;
a switched fabric communication medium coupling the plurality of storage controllers with each of the plurality of storage devices; and
a solid-state drive (SSD) coupled with each of the plurality of storage controllers through the switched fabric communication medium,
wherein each of the plurality of storage controllers uses the SSD as a cache memory,
wherein the SSD further comprises:
a volatile random access memory (RAM) for storing cached data;
a non-volatile random access memory (NVRAM); and
a controller circuit coupled with the RAM and coupled with the NVRAM, the controller circuit coupled with each of the plurality of storage controllers through the switched fabric,
wherein the controller circuit is adapted to present the storage of the RAM as a disk drive when coupled with an external device,
wherein the controller circuit is further adapted to receive cached data from any of the plurality of storage controllers and further adapted to store received cached data in the RAM,
wherein the controller circuit is further adapted to sense an impending loss of external power to the SSD, and
wherein the controller circuit is further adapted to copy cached data stored in the RAM into the NVRAM responsive to sensing the impending loss of external power.

14. The system of claim 13
wherein the NVRAM is a flash memory.

15. The system of claim 13
wherein the controller circuit couples with each of the plurality of storage controllers using one of: a Serial Advanced Technology Attachment (SATA) interface and a Serial Attached SCSI (SAS) interface.

16. The system of claim 13
wherein the RAM and the NVRAM have substantially the same storage capacity.

17. The system of claim 13 further comprising:
a local power source integral with the SSD for supplying temporary power to the SSD in the event of a loss of external power to the SSD,
wherein the controller circuit is further adapted to copy cached data stored in the RAM into the NVRAM using power from the local power source.

18. The system of claim 16
wherein the local power source is a super-capacitor.

19. The system of claim 13
wherein the controller circuit is further adapted to sense restoration of external power, and
wherein the controller circuit is further adapted to copy cached data from the NVRAM to the RAM responsive to sensing restoration of external power.
